(19) United States
(12) Patent Application Publication
(10) Pub. No.: US 2014/0158516 A1
(43) Pub. Date: Jun. 12, 2014

(54) Water Supply Systems

(71) Applicant: Mads Landrok, San Jose, CA (US)

(72) Inventor: Mads Landrok, San Jose, CA (US)

(21) Appl. No.: 13/709,041

(22) Filed: Dec. 9, 2012

(51) Int. Cl. C02F 1/12

(52) U.S. Cl. CPC C02F 1/12
USPC 203/10; 202/175

(57) ABSTRACT

Water supply systems use readily available heat sources like the sun and waste heat from industrial plants to heat intake air and water so more water can be used to saturate the intake air. That extra water is condensed out at another place even miles away where the now distilled water would be more useful.

### RELATED APPLICATION

This application claims benefit of and is a Continuation-In-Part of International Patent Application PCT/GB2012/050673, with a filing date of 27 Mar. 2012, and a priority date of 15 Apr. 2011 (Published as GB2489989A), in the name of Mads Landrok, and titled “Water Supply Systems”. This was thereafter published internationally on 18 Oct. 2012 under number WO/2012/140405.

### BACKGROUND OF THE INVENTION

1. Field of the Invention

The present invention generally relates to potable water devices and mechanisms, and more particularly to the desalination of large amounts of water at relatively very little expense of energy.

2. Background of the Invention

Large-scale desalination typically requires large amounts of energy and specialized heavy equipment, making it much more costly than fresh water obtained from rivers, ground water, and other natural sources. The areas of the world that lack adequate sources of natural potable water have no other choice than to pay the premiums imposed by large-scale desalination.

Conventional water desalination techniques for purifying fresh water from seawater include multi-stage flash distillation (MSF) using concurrent heat exchangers, reverse osmosis using pressurized membranes, and vacuum distillation. An interesting system is described (in German) by Hendrik Müller Horst in his PhD dissertation at Technical University of Munich, titled “Multiple Effect Humidification Dehumidification at Ambient Temperatures”. Such describes using a solar collector to heat seawater which afterwards enters an evaporation chamber to extract a distillate from the subsequent condensation of the generated steam.

The “dew point” is the temperature below which water vapor in humid air at a constant barometric pressure will condense out into liquid water droplets. The dew point is a water-to-air saturation temperature and is related to relative humidity (RH). A high relative humidity means the dew point is close to the current air temperature. A relative humidity of 100% means the dew point is equal to the current temperature and that the air cannot absorb any more water, evaporation will stop. If the dew point remains constant and the temperature is increased, the relative humidity measure will decrease.

At a given temperature independent barometric pressure, the dew point is a consequence of absolute humidity, the mass of water per unit volume of air. If both the temperature and pressure rise, however, the dew point will rise and the relative humidity will lower. Reducing the absolute humidity without changing other variables will bring the dew point back down to its initial value. In the same way, increasing the absolute humidity after a temperature drop brings the dew point back down to its initial level. If the temperature rises in conditions of constant pressure, then the dew point will remain constant but the relative humidity will drop. For this reason, a constant relative humidity (%) with different temperatures implies that when it's hotter, a higher fraction of the air is water vapor than when it's cooler.

At a given barometric pressure independent of temperature, the dew point indicates the mole fraction of water vapor in the air, or, put differently, determines the specific humidity of the air. If the pressure rises without changing this mole fraction, the dew point will rise accordingly; Reducing the mole fraction, i.e., making the air less humid, would bring the dew point back down to its initial value. In the same way, increasing the mole fraction after a pressure drop brings the relative humidity back up to its initial level. Considering New York (33 ft elevation) and Denver (5,280 ft elevation), [2] for example, this means that if the dew point and temperature in both cities are the same, then the mass of water vapor per cubic meter of air will be the same, but the mole fraction of water vapor in the air will be greater in Denver.

An eduction distillation system for treating salt water to produce fresh water was described by H. C. Kelley, Jr., in U.S. Pat. No. 3,414,481, issued Dec. 3, 1968. The invention relies on convection and topology for transport, and pulls air up using a wind-wheel (for example) shortly before condensing. Kelley does not use spraying of the input water to assist evaporation. Instead, a hood collector suspended over a covered evaporation bed of semi-heated water is used for better operation. Any wind-wheel at the top as described shortly before the condensation station would likely affect a low pressure point, causing unwanted condensation by the pressure reduction. Any concomitant build-up of pressure right before condensation needs to occur is adverse to the subsequent condensation.

### SUMMARY OF THE INVENTION

Briefly, a water supply system embodiment of the present invention includes a spray evaporation station located at a salt water or other raw water source, and an air conduit to collect natural heat and carry humidified air to a condensation station with a fresh water outlet. Air pressure changes and heating/cooling are induced at various parts of the system to stimulate evaporation and later to provoke condensation.

These and other objects and advantages of the present invention will no doubt become obvious to those of ordinary skill in the art after having read the following detailed description of the preferred embodiments of the present invention that are illustrated in the various drawing figures.

### IN THE DRAWINGS

FIG. 1 is a schematic diagram of water supply system embodiment of the present invention in which an evaporation station is located on the edge of an ocean and the condensation station is located on the dry side of a nearby mountain range;

FIG. 2 is a schematic diagram of closed-loop water supply system embodiment of the present invention in which an evaporation station and a condensation station are collocated on the edge of an ocean. A heat absorbing pipe is looped through a nearby desert to pick up operational heat;

FIG. 3 a schematic diagram of water supply system embodiment of the present invention that uses differences in the day/night temperatures by the ocean and on land;

FIG. 4 is a chart representing the humid air temperatures and the dew point along a long connecting pipe run. The temperatures are allowed to fall below the dew point at the condensation station;

FIG. 5 is a schematic diagram of an evaporation station embodiment of the present invention showing details of the evaporation spray nozzles;

FIG. 6 is a schematic diagram of a transport piping embodiment of the present invention showing details of the system that follow the evaporation spray nozzles at the evaporation station and run to the condensation station;

FIG. 7 is a schematic diagram of a condensation station embodiment of the present invention showing details of the use of nano-materials before and after the condensation threshold line;

FIG. 8 is a side view diagram of a spiral conduit embodiment of the present invention;

FIG. 9 is a perspective view diagram of a spiral conduit embodiment of the present invention; and

FIG. 10 is a schematic diagram of a stacked pair of spiral conduits in an embodiment of the present invention.

### DETAILED DESCRIPTION OF THE PREFERRED EMBODIMENTS

Large amounts of water vapor can be easily transported long distances and even uphill with very little expenditure of energy. In warm dry climates, natural water evaporation efficiencies can be set to work to put humid air where it can best be used to improve and realize surprisingly practical water desalination.

Water supply system embodiments of the present invention include an evaporation station located at a salt water or other raw water source, long air conduit or pipe to collect natural heat and carry humidified air, and a condensation station with a fresh water outlet. Air pressure changes are induced at various parts of the system to stimulate evaporation and to provoke condensation.

These systems will work for most minerals, not only salt. Impure water can be freed from a number of non-evaporable substances, e.g., selenium, as in pollution clean-up purposes.

The typical pipe can be as little as ten meters long, or as long as tens of kilometers with cross-section areas of 1-10 square meters. In one embodiment, the pipe, the evaporation station, and then condensation station define an air path configured as a closed-loop. In other embodiments, the condensation station is located at a significantly higher elevation than the evaporation station. For example, a thousand meters above the evaporation station on a nearby hill or on top of a tall building.

Some advantages may be obtained by co-locating both the evaporation and condensation stations close to a large body of water. Water flows may be used to make condensation more efficient by providing large volume cooling. When a condensation station is put high enough above an evaporation station, the water head caused by fall of the condensed water can be used for hydroelectric power generation.

It is very advantageous for the pipes that connect to evaporation stations to the condensation stations to be heated by sun exposure. Wide profiles flat to the sun and solar absorption coatings can help. Solar radiant heat absorbance of 40%-90% at wavelengths in the range 300-nm to 2000-nm are possible and transparent vacuum evaporated covers will be helpful to trap and maintain heat in the system.

Any solar energy input is cost-free will help keep the air humidified as it transits the system. Elevated temperatures allow the air to maintain its water vapor content on its way to the condensation station. Painting the pipe black and texturing the surface of the pipe are typical ways to increase solar heat absorption.

Specialized solar heaters and concentrators can be used as supplemental ways to heat the pipe, e.g., a series of mirrors along the pipe to gather and direct sunlight towards the pipe. The pipe itself may further be configured to store heat efficiently, and/or be thermally insulated.

Solar energy alone may not be enough to keep the humidified air in the pipe warm enough, especially when the humidified air must be risen to a substantial height above the evaporation station. The air temperatures can drop in spite of significant solar energy input to the humidified air. So the piping may need to be heated using other more powerful and dependable energy sources, e.g., waste heat from a data center, or coolants from a fossil or nuclear power station.

Water will naturally condense and drop out of the airflow as the temperature of the humidified air drops. So water collection and extraction points along the length are needed to remove the condensed water from the pipe and put it to use. The humidity of the air leaving the evaporation station is adjusted such that the relative humidity (RH) as it arrives at the condensation station is kept below 100%, e.g., 80% to 90% RH.

Fans or turbines may be used to drive the humidified air from within the air conduit.

The water evaporators can use spray evaporators to deliver substantial volumes of water into fast moving air. One such water evaporation system comprises sets or rings of nozzles within the air conduit, after the turbines or fans in a direction of the airflow, pointed to direct water droplets into a direction of the airflow. In embodiments of the present invention the airflow can be 1-30 meters per second. Preferably an average dimension of a water droplet is no more than 100-500 micrometers to help promote rapid evaporation. Substantially all the water received by a water evaporation station may be converted into water vapor.

When the system is used to collect and evaporate salt water, a brine collection system is included to carry away the brine that precipitates during the water evaporation process. Such a desalination system may be useful on a sea-going vessel.

Some systems are configured to take advantage of the difference in heating and cooling between the ocean nearby deserts. In one embodiment of the present invention a controller included in the evaporation station is used to manage the day/night operation of the system. A forced air flow is used at night when the relative temperature differences between evaporation and condensation stations is larger. Water storage pools are connected to the evaporation stations, thermally insulated to retain their heat soak. Their water inlets may be heated, e.g., by solar heaters and concentrators, or by waste heat/power from a power station. The controllers are configured to draw water into the pools for heating during the day, and to the initiate forced airflows at night.

Condensation stations may include Sterling heat engine, or other energy harvesting system, driven by temperature differences of as much as 50° C., by thermal coupling to a heat exchanger. Energy from the heat engine may be employed to drive the water evaporation and airflow driving systems.

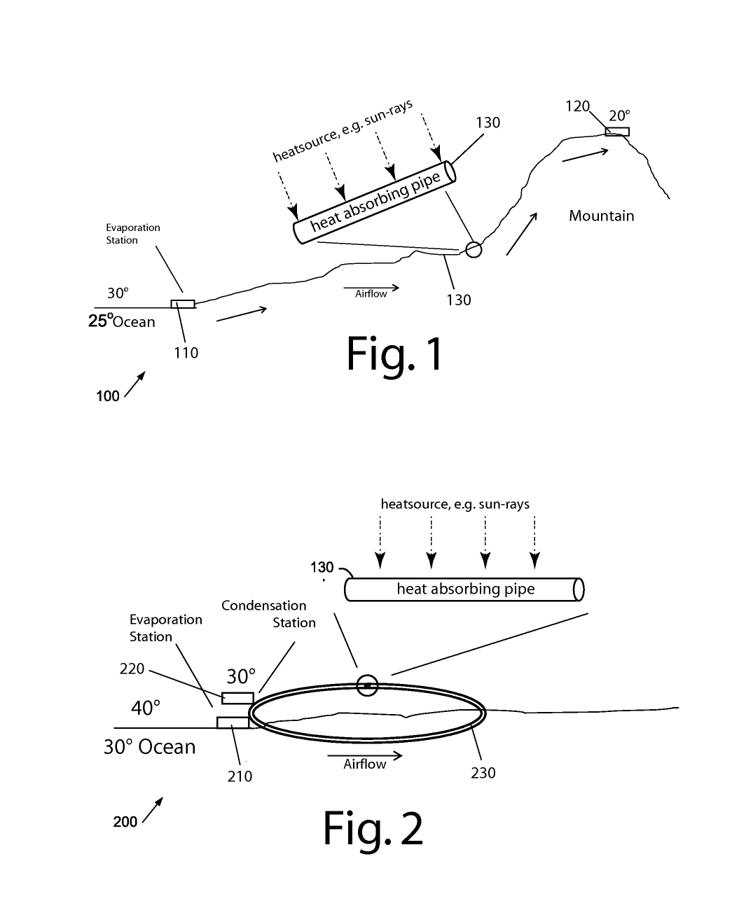

FIG. 1 represents a water supply system 100 comprising an evaporation station 110 located at the edge of an ocean, sea, of salt lake; a condensation station 120 located on top of a nearby hill or mountain; and an interconnecting heat-absorbing pipe 130 to carry humidified air. Any water condensation that may collect at low points in the interconnecting heat-absorbing pipe 130 is removed by tapping off the liquid water or re-evaporating it back into the airflow.

Ocean temperatures can be on the order 25° C. (77° F.), with local air temperatures of 30° C. (86° F.). Typical heat-absorbing pipes 130 can heat the humidified air inside as much as 60° C. (140° F.). Condensation of the humidified air can occur if the local air temperatures drop to 20° C. (68° F.).

The evaporation station 110 includes a water inlet, spray evaporators, and sometimes powered wind turbines. Natural convection alone can be used to draw in and push warm, humidified air up to the condensation station 120. But for improved evaporation efficiency and greater water transport, it is preferable to add a forced air drive. In closed loop systems, many forced drives or turbines may be needed at and between the evaporation and condensation stations 110 and 120.

Condensation station 120 includes heat exchangers in combination with throughs and gutters to collect the water as it condenses out of the humidified air. A return pipe may be included from the condensation station 120 back to the evaporation station 110 to propel greater air flow speeds.

A typical system 100 as shown in FIG. 1 can have a pipe 130 with a radius r=5.64m, a cross-sectional equivalent area of 100 square meters, and laid out 100-km long. Design airflow velocities in pipe 130 can approach 30-m/s, which moves as much as 3,000 cubic meters per second of humidified air. The water saturation at 20° C. is 0.017 kg/m³, and at 30° C. is 0.030 kg/m³, so the difference Δ (30° . . . 20°) is 0.013 kg/m3, for 39-kg H₂O/second, or 140,400 liters of water per hour (37,090 gallons per hour).

In various embodiments that were conducted, evaporation station 110 included a device to collect brine, a byproduct of the evaporation process. The brine was returned to the ocean. Brine collection features may also be embedded in pipe 130 to provide outlets along the length.

FIG. 2 represents an alternative water supply system 200, in an embodiment where a closed loop air flow between an evaporation station 210 and a condensation station 220 is supported by a pipe 230. Turbines placed inside pipe 230 are used to perk up the air flow. As illustrated, evaporation station 210 and condensation station 230 are substantially co-located at an ocean edge. The collocation facilitates water condensation at condensation station 130. Solar energy and heat to support evaporation and maintenance of the air humidity is collected into system 200 by long runs of exposed pipe 230. Pipe 230 itself can be opaque black or transparent clear to promote heat absorption.

In an exemplary system 200, pipe 230 can have a radius r=3.99 meters, e.g., equivalent cross-sectional area of 50 m², and is laid out in a long loop. The airflow velocity in the pipe is 30-m/s, yielding 1,500 m³ air per second. When the water saturation at 30° C. is 0.030 kg/m³, at 50° C. it is 0.083 kg/m³; for a difference Δ (50° . . . 30°) of 0.053 kg/m³, or 79.5 kg H₂O/second, 286,200 liters per hour, or 75,606 gallons per hour.

In a second example, the pipe radius r=1.78 m, for an area of 10-m². The pipe is 1000 meters long laid out in a loop, 159 meters in radius. An airflow velocity of ten meters per second yields a volume flow of 100-m³ per second. Saturation at 30°:0.030 kg/m³; 60°:0.130 kg/m³=>Δ (60° . . . 30°):0.100 kg/m³=>100-kg H₂O/second=360,000 liters/hr=95,100 gallons/hr.

In a third example, the pipe (r=0.56 m, an area of one square meter) is laid out in a loop, 15.9 m in radius, 100-m long. An airflow velocity of ten meters per second=>ten cubic meters of air per second. With the water saturation at 30° C.:0.030 kg/m³; and at 50° C.: 0.083 kg/m³; then=>Δ (50° . . . 30°):0.053 kg/m³; and =>0.530 kg H₂O/second=1,908 liters per hour=504 gallons per hour.

In general, the surface/evaporation rate can be increased many times by increasing airflow velocity. Actively dispersing or spraying water into fast moving air will increase the rate of water that can be evaporated. Wind turbines can be used in combination with active dispersion for further increases in the evaporation rates.

Some embodiments transport the water vapors up and out from the evaporation station. The evaporation stations can receive a steady flow of water to be purified, no input reservoir or forebay is required. In configurations where the condensation station is at much higher elevation, and/or in a colder local climate, the kinetic energy from distribution of the condensed water can be sold, as well as making use of natural differences in temperature.

It is advantageous to set the humidity of the air in the pipe such it arrives with a relative humidity of 100% at the condensation station, otherwise inefficiencies result. The temperature of the pipe immediately prior to the condensation point may be lower than in other parts of the pipe, e.g., due to reduced temperatures at the condensation station.

FIG. 3 represents a system 300 in which a condensation station 320 is located at the far end of a connecting pipe 330 in a dry desert. An evaporation station 310 intakes water from a set of nearby pools 340. The pools are thermally insulated. During the day, seawater at 15° C. to 35° C. is lead in or pumped into the pools for heating by solar concentrators. Such water can acquire relatively high temperatures of 30° C. to 80° C. by the end of a day. At night, system 300 vents water vapor through connecting pipe 330 for transit to condensation station 320. In the desert, the nights can be as cold as 10° C. Generally the ambient temperatures of desert land will drop faster than that of large bodies of water. Even without heating of the pools, system 300 can provide useful advantages.

The pipe 330 may be provided along some or substantially all of its length with heat storage means for storing heat from an external source. This helps to retain the externally supplied heat during the day, and also provides a degree of thermal isolation of the pipe at night. Similarly, externally supplied heat may be provided along some or substantially all of the length of the pipe. This external heating may include a solar concentrator partly surrounding the pipe, e.g., a set of mirrors at intervals along the length of the pipe. Or such heat may be supplied by using fossil fuel, or by employing waste heat from another source.

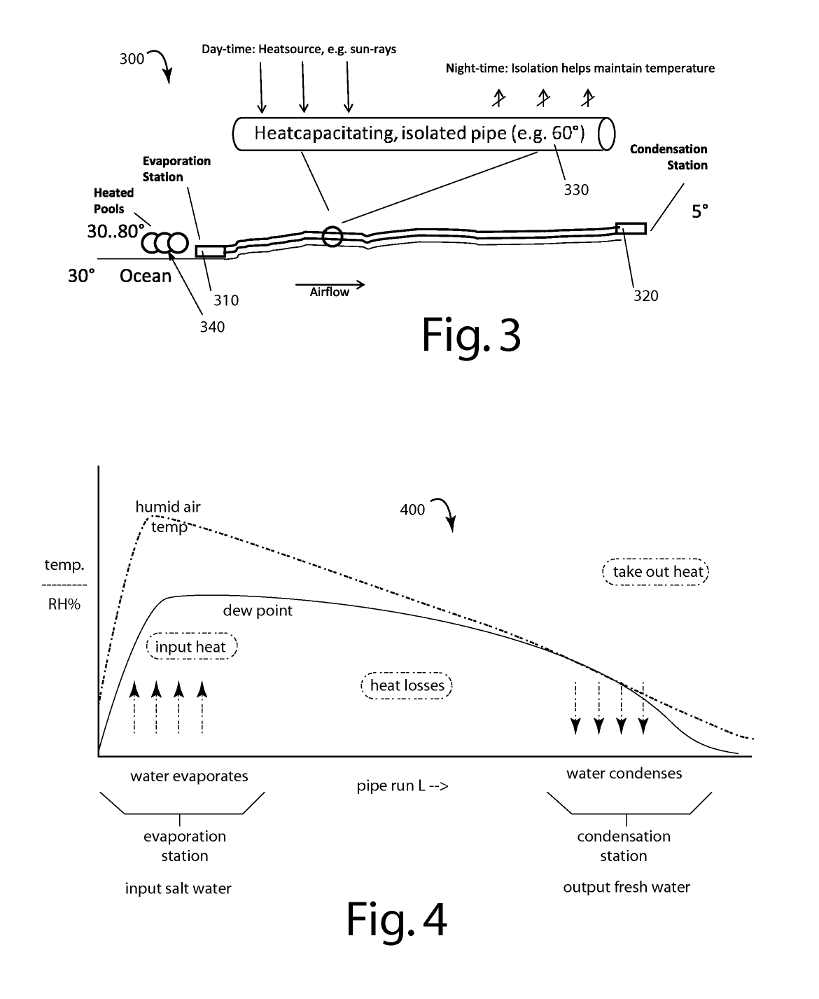

FIG. 4 uses a chart 400 to summarize the general theory of operation. The higher the dew point temperature is, the higher the moisture content of humid air. The amount of water the air is holding versus the amount it can hold at this temperature is the percentage relative humidity (RH). Heating the air will enable it to hold more water to a point, and cooling humid air below its dew point will cause water to condense out as droplets. So embodiments of the present invention use readily available heat sources like the sun and waste heat from industrial plants to heat intake air and water so more water can be used to saturate the intake air. That extra water will be condensed out at another place where the now distilled water would be more useful.

Dew point temperature is a better absolute measure of moisture in the air, it doesn't change when the air temperature changes. Dew point only changes when the moisture content changes. So FIG. 4 shows a rapid upswing of the dew point temperature at the evaporation station from a rapid increase in both the temperature and the water saturation. The relative humidity is only allowed to approach 100% at the condensation station, there the temperatures are forced down to compel condensation. Low relative humidity's caused by heating will promote evaporation at the evaporation station and a consequential steep rise in the dew point. No condensation will occur in the pipe if the relative humidity at every point stays under 100%. Since the ambient pressures stay more or less the same, the local temperatures will effectuate the biggest control effect.

Evaporation and sprayers are used to humidify the air, and the humid air rises or is pushed to a condensation station that can be miles away. At the far end, the temperatures are allowed or forced to drop, and that drop precipitates liquid water because the relative humidity of the cooler humid air rises to 100%.

Large amounts of water can thus be transported this way, and the water is naturally distilled without boiling as it transits the system. Given the amount of water that can be produced, the pumping and heating costs are quite minimal.

Raw water from a large body of water is input and evaporated for transport by a pipe. Raising the temperature of the water, the air, and the pipe will reduce the relative humidity and allow more water to be absorbed to saturate the intake air. A cheap source of large scale power is solar heating of the holding pools and transport pipes.

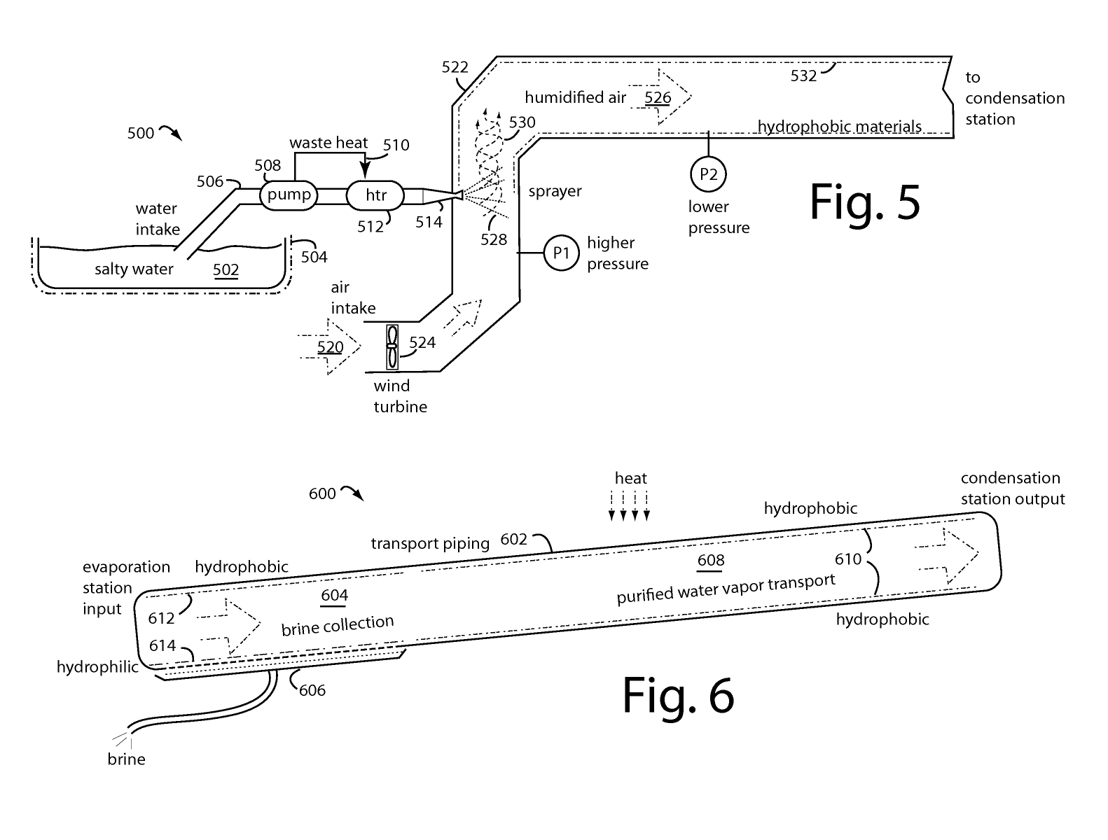

FIG. 5 represents an improved evaporation station 500 that collects salty water 502 in a thermally insulated bladder, pond, or pool 504. A water intake 506 is connected to a pump 508. Waste heat 510 and other heat sources are fed into a water heater 512 to raise the water temperature before being forced through an array of spray nozzles 514.

An air intake 520 at the beginning of an air duct 522 can use a wind turbine 524 to push humidified air 526 past the spray nozzles 514. It may be advantageous to arrange the diameters and geometries of air duct 522 such that a higher pressure (P1) exists around the spray nozzles 514 than farther downstream where there is a lower pressure (P2). Such would help a spray 528 evaporate better.

It is preferable to raise the temperature of the input water before its being sprayed in the evaporators. Solar heat is used wherever possible to raise the temperature of the intake water and air. Heating from conventional heat sources such as, e.g., fossil fuels, but may also include techniques like transporting the input water through pipes 506 coated to absorb as much sunlight as possible. Many alternatives are possible ranging from dark painted pipes to pipes coated with nano-particles, conductive carbon or metallic parts for improved heat dissipation. Sunlight may be aimed at the pipe 506 directly, or by reflective shaped mirrors, round, elongated cross sections of a pipe, various mirrors angled for the purpose, as well as through prisms aimed at concentrating light or changing its wavelengths, conventional, Fresnel, and other types of simple lenses. Heater 512 simplifies and represents all these methods.

In order to keep the energy captured as heat, it is natural to consider insulating the system. One promising method used in the solar heating space is the use of vacuum evaporated tubes that surround a heated pipe.

A bit of pressure from pump 508 is required to take in the input water 502 and to force it through nozzles 514 to make it spray 528. A Sterling Engine is a heat engine that can be used for pump 508 that functions by the compression and expansion of gases or working fluids as they cool and heat. A natural heat source like the sun can supply the needed energy very inexpensively, and a variety and combination of mirrors and lenses can be used to maximize the advantages. Sterling Engines are noted for their efficiency, but will still dissipate heat. The Sterling Engine is configured here in such a way that escaping waste heat 510 is captured and used to heat intake water 502.

Various optimizations of the air duct for the water droplets as they leave the nozzles includes designing the air pressure to higher at and immediately following the nozzles before allowing it to normalize in the long-haul transportation pipes. This could be achieved by simple adjustments of the pipe diameter, before, at, and following the spray nozzles. In more refined implementations, shapes causing spiraling or twisting airflows to meet just after the nozzles, may be combined in a way that the vortexes are angled in a manner to collide and thus cause an increased pressure stream as follows (see FIG. 1: the illustration only shows two incoming streams, but may consist of more than two).

From the spray nozzles onwards, the insides of the transport pipes and ducts are preferably coated with or compromised of hydrophobic materials, disallowing a build-up of dew in spots experiencing localized pressure drops.

FIG. 6 represents an interconnect 600, in an embodiment of the present invention. It transports humidified air produced by an evaporation station interconnected with a condensation station. A pipe 602 can be as large as ten meters in diameter and ten kilometers long. It may be externally coated with conventional insulation and/or heat absorbing materials, and it can be fitted with various kinds of spot or continuous length heaters.

A principle objective in the transport of the humidified air between the evaporator and condenser stations is to maintain a sufficiently high temperature of the internal airflows to forestall condensation. (At the condensation station a rapid and complete condensation is desirable.) In a first part 604 of the transport piping 602, input water droplets may not have fully evaporated because of entrained salts and the lighter droplets can remain suspended and carried downstream in the humidified air. For example, a briny mist can stay behind in cases where seawater is used as the input water. A brine collector 606 is needed in the bottom of the pipe as the mineral salts “rain down”. Some water in the briny mist will continue to evaporate and help saturate the humidified air. Any briny mist arriving at the end at the condensation station is undesirable. The transport part of the system can therefore be divided into brine collection 604, and purified water vapor transport 608.

In general, the goal is to circumvent any condensation of the pure water after all the salts have rained off. The downstream sections of the pipe following brine collection are internally layered with hydrophobic (water repelling) nano treatments 610. In the first section, salt and brine needs to be quickly eliminated. So the inside upper half of the pipe is treated with a hydrophobic coating 612, and the inside lower half of the pipe is treated with a hydrophilic (water loving) coating 614 to encourage the outflows of brine.

In alternative embodiments where too much briny mist is being carried in the airflow, it may be advantageous to include fine nets 620. Vaporized pure water will carry through unimpeded. The saline droplets will collect on the nets and run down through brine collectors. It could also be helpful to incline the airflow as it passes through a series of nets. The actual webbing should not be cool or cold such that condensation of the pure water vapor occurs. To this end the net webbing should be non-metallic unless they were actually heated from outside energy sources.

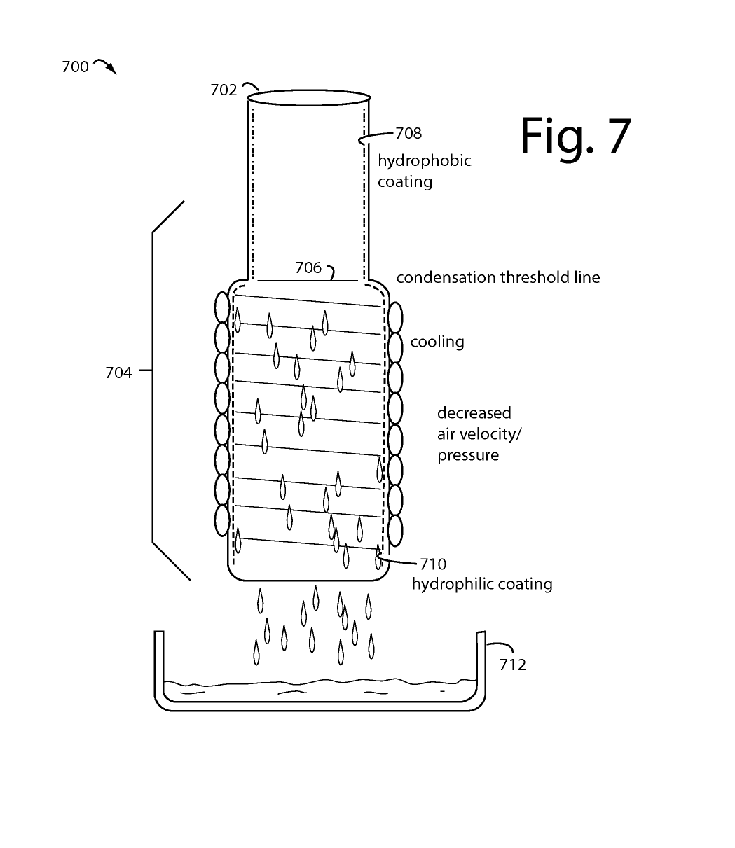

FIG. 7 represents a part of a condensation station 700 that receives a connection piping 702. Expanding the diameter of the pipe can slow down a humidified airflow 703 to promote more efficient cooling, and the slight pressure drop can initiate condensation inside the flare. One method is to use two opposite types of nano coatings inside a reversed funnel 704, and positioning the funnel in a way that allows a water runoff condensate 705 to take advantage of gravity.

A critical point exists inside the funnel herein called a “condensation threshold line” 706. Water droplet formation in front of the condensation threshold line is undesirable, so the funnel entry is provided internally with a hydrophobic coating 708. Once the airflow moves past the condensation threshold line 706, water droplets can be encouraged to form, e.g., on the inside surface of the funnel with a hydrophilic coating 710. The airflow and gravity are depended upon to help “roll off” the water droplets into collectors 712.

Some embodiments of the present invention fold the connecting pipe to compact the whole system. For example, where the evaporating and condensing stations need to be collocated or operated near to one another. Hard, sharp folds and turns, like in a rectangular maze, are largely unsuitable because the hard turns can generates vortexes where the local pressures can rise and fall. These pressure gradients can cause water vapor to condense before its arrival where it's needed and thus be wasted.

Fermat's Spiral is a type of parabolic spiral in equiangular nautilus form where airspeeds and pressures are more controlled and more uniform. Various other kinds of spirals may have good application in this context, e.g., Archimedean, logarithmic, etc. Such spirals can be used to compactly heat or cool internal flows of humidified air to control evaporation and subsequent condensation processes. A complete water desalination system using such panels could be installed and provide substantial amounts of fresh water within a single ocean-going ship or industrial building.

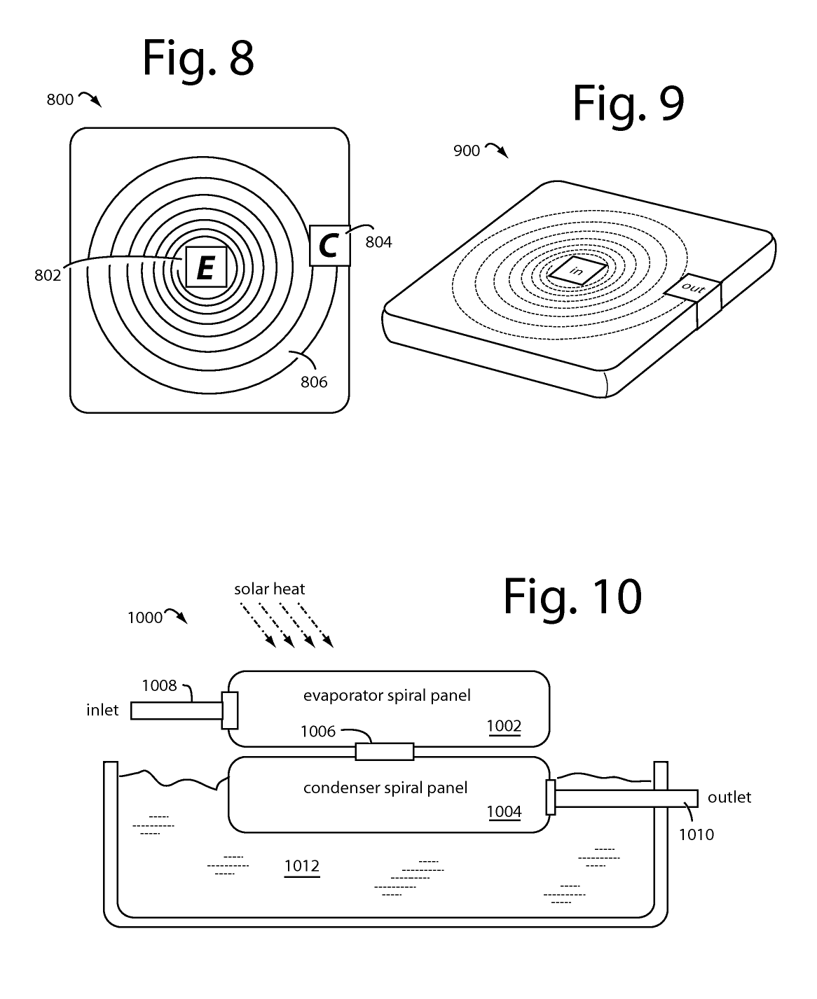

Referring now to FIG. 8, the folded connection pipes are fabricated into practical sized panels 800 that variously can optimize evaporation and/or condensation. The goal is to create a compact device that has a long enough “run” to evaporate all the water droplets and for the salt to “rain off”. Here, an evaporation station (E) 802 inject water vapor and a condensation station (C) 804 are interconnected by a spiral passageway 806.

Circular and spiral designs optimize the space consumed and avoid crooked turns that can cause local irregularities and anomalies in pressure large enough to provoke unwanted spots of condensation.

FIG. 9 represents a spiral conduit embodiment of the present invention, and is referred to herein by the general reference numeral 900. Here, constructed as a panel or box, spiral conduit 900 has an input for humidified air at its center and an output at one edge.

FIG. 10 represents a stacked panel embodiment of the present invention, and is referred to herein by the general reference numeral 1000. Stacked panel 1000 has two individual spiral conduits 1002 and 1004 interconnected by a central coupler 1006. Here, the upper panel 1002 functions as an evaporator that is exposed to solar heat and has an inlet 1008. The lower panel 1004 functions as a condenser and has an outlet 1010 for distilled water. A pool of water 1012 helps chill condenser spiral conduit 1004 and that will promote condensation from the water vapor in the humidified air circulation.

It may be advantageous to insert at least one airflow balancing mechanism between the evaporation and condensation stations to maintain a quasi constant airflow through the connecting air transport pipe. For example, the cross-sectional areas of the pipe are configured to balance out pressure excursions, or wind turbines, fans, and propellers can be used, as illustrated in FIG. 5.

Although the present invention has been described in terms of the presently preferred embodiments of the present invention, it is to be understood that the disclosure is not to be interpreted as limiting. Various alterations and modifications will no doubt become apparent to those skilled in the art after having read the above disclosure. Accordingly, it is intended that the appended claims be interpreted as covering all alterations and modifications as fall within the “true” spirit and scope of the invention.

What is claimed:

1. An improved water supply system that includes an evaporation station, a connecting air transport pipe for humidified air, and a condensation station, the improvement comprising:
a number of spray nozzles for evaporating an intake of salty water into a humidified airflow; and
an intake air duct configured to increase the air pressure before and proximate to the spray nozzles, and to thereafter drop the air pressure of the humidified airflow;
wherein, the combination is configured to produce fresh water from a continuous raw water input supply.

2. The improved water supply system of claim 1, further comprising:
at least one airflow balancing mechanism inserted between the evaporation station and condensation station to maintain a quasi constant airflow through the connecting air transport pipe, wherein the cross-sectional areas are configured to balance out pressure excursions.

3. The improved water supply system of claim 1, further comprising:
a spiral conduit configured to replace the connecting air transport pipe for humidified air;
wherein, a more compact water desalination system is made possible.

4. The improved water supply system of claim 1, further comprising:
an evaporation spiral conduit configured to replace the connecting air transport pipe for humidified air;
a heating device arranged to input heat into the evaporation spiral conduit and thereby instigate evaporation within the evaporation spiral conduit;
a condensation spiral conduit connected to receive the humidified air from the evaporation spiral conduit;
a cooling device arranged to take away heat from the condensation spiral conduit and thereby initiate condensation;
wherein, a more compact water desalination system is made possible.

5. The improved water supply system of claim 1, further comprising:
a controller configured to cause water to be drawn into a water storage pool to be stored and heated during the day, and configured to drive an airflow out from the evaporation station at night.

6. A method for transporting and distilling water from an evaporation station to a condensation station connected by a transport pipe, comprising:
raising the dew point of an intake of air by a combination of heating and evaporation of a water source to produce a humid air volume;
conducting the humid air volume at less than its dew point from an evaporation station to a condensation station;
exposing the humid air volume to temperatures below the dew point at the condensation station; and
collecting a water condensate from precipitations of the humid air volume;
wherein, the steps of raising and transporting are such that the humid air volume arrives at the condensation station at 100% relative humidity.

7. The method of claim 6, further comprising:
collocating the evaporation station at the edge of a large body of water;
positioning the condensation station at an elevation substantially higher than the evaporation station; and
separating the condensation station and the evaporation station by miles.

8. The method of claim 6, further comprising:
raising the temperatures of the intake air and/or the water source with solar collectors or exposure.

9. The method of claim 6, further comprising:
pointing a spray of water droplets into a direction of said airflow.

10. The method of claim 6, further comprising:
removing any water condensation that may collect at low points in an interconnecting transport piping by tapping off the liquid water or re-evaporating it.
